(19) United States
(12) Patent Application Publication
(10) Pub. No.: US 2011/0089858 A1
(43) Pub. Date: Apr. 21, 2011

(54) LOAD DRIVING CIRCUIT AND MULTI-LOAD FEEDBACK CIRCUIT

(75) Inventors: Chen-Hsung WANG, Xinzhuang City (TW); Chung-Che YU, Xizhi City (TW)

(73) Assignee: GREEN SOLUTION TECHNOLOGY CO., LTD., Xizhi City (TW)

(21) Appl. No.: 12/695,451

(22) Filed: Jan. 28, 2010

(30) Foreign Application Priority Data
Oct. 16, 2009 (TW) 98135006

(51) Int. Cl. H05B 41/36

(52) U.S. Cl. 315/294

(57) ABSTRACT

A load driving circuit and a multi-load feedback circuit are disclosed. The load driving circuit and the multi-load feedback circuit are adapted to drive an LED module comprising a current balancing circuit for balancing the current flowing through LEDs. The load driving circuit and the multi-load feedback circuit modulate the electric power transmitted by the LED driving apparatus to an LED module according to voltage level(s) of one or more current balancing terminals having insufficient voltage in the current balancing circuit, so the voltage levels of the current balancing terminals are higher than or equal to a predetermined voltage level, further increasing the efficiency thereof.

### BACKGROUND OF THE INVENTION

1. Field of the Invention

The present invention relates to a load driving circuit and a multi-load feedback circuit; in particular, it relates to a load driving circuit and a multi-load feedback circuit used to drive plural series connections of Light Emitting Diodes (LEDs).

2. Description of Related Art

Refer first to FIG. 1, wherein a schematic diagram of a conventional constant current driving apparatus for LEDs is shown. The illustrated LED constant current driving apparatus comprises a current balancing circuit 10, a LED module 60 and an electrical power supply 70. The electrical power supply 70 stabilizes the output voltage VOUT through a voltage feedback signal VFB generated by a voltage feedback circuit. The LED module 60 consists of plural series connections of LEDs connected in parallel between the electrical power supply 70 and the current balancing circuit 10. The current balancing circuit 10 consists of a current setting resistor 11 as well as a current mirror composed of a transistor 12 and multiple transistors 20. One terminal of the current setting resistor 11 is coupled to a voltage VCC, and the other terminal thereof coupled to the transistor, thereby allowing a setting current to flow through the transistor 12. The transistor 20 is one-to-one, individually connected to a corresponding series connection of LEDs in the LED module 60, and mirrors the setting current, thereby allowing the setting current to flow through the LEDs for light emissions. In this way, largely equivalent current can flow through each LED in the LED module 60, so that the illumination brightness is similar.

Due to significant differences in threshold voltages between the LEDs, the required drive voltage value to maintain the same current may vary. For example, with a current of 20 mA flowing therein through, the required drive voltage for one single LED is roughly within a range of 3.4˜3.8V, and since each series connection of LEDs in the LED module 60 consists of 20 LEDs, the required drive voltage for one series connection of LEDs is accordingly within a range of roughly 68˜76V, and the difference in the drive voltage between each series of LEDs is endured by the transistor switch 20. Besides, the transistor switch 20 can demonstrate full performance of current mirroring only when operating in the saturation range. Therefore, to ensure each series connection of LEDs to acquire the same current flowing therein through, the output voltage VOUT provided by the electrical power supply 70 must be higher than the maximum drive voltage, e.g., 80V, thereby ensuring the transistor switch 20 to operate in the saturation range.

Nevertheless, the drive voltage required by the series connection of LEDs is unlikely to be individually confirmed beforehand, so the maximum drive voltage for the series connection of LEDs in the LED module 60 may not be necessarily as high as 76V. As a result, excessive provision of 80V as the drive voltage may contrarily cause reduced efficiency in illuminations. Furthermore, to prevent non-illumination in LED due to open-circuit damage of each LED in the series connection of LEDs, some LEDs can be connected in parallel to a Zener diode, such that current can be successfully conducted through the Zener diode even the LED connected in parallel is open-circuit damaged. The breakdown voltage in the Zener diode is set to be higher than the threshold voltage of LED, e.g., 2V., so as to prevent occurrences of erroneous actions in the Zener diode. Under such circumstances, if two LEDs are damaged in a series connection of LEDs, thus resulting in approximately 4V increments in the drive voltage of the series connection of LEDs, it is possible to lead to significant reduction in the current flowing through the series connection of LEDs or even a consequence of non-illumination. Whereas, in case the output voltage VOUT provided by the electrical power supply 70 is enhanced, efficiency of light emission may be undesirably lowered.

### SUMMARY OF THE INVENTION

In view of that, to ensure stable light emissions for the LED module, the conventional constant current driving apparatus for LEDs provides a drive voltage higher than the required voltage, yet the overly high drive voltage may cause lowered efficiency of the LED driving apparatus. The present invention is directed to resolve the efficiency issue of the LED driving apparatus by, in accordance with the voltage level associated with one or more current balancing terminals having insufficient voltage level in the current balancing circuit of the LED driving apparatus, adjusting the electric power required to drive the LED module in the LED driving apparatus, such that the LED driving apparatus is allowed to operate at an improved efficiency by means of consistency in current flowing through each series connection of LEDs of the LED module.

To achieve the aforementioned objective, the present invention provides a multi-load feedback circuit which allows a load driving circuit to adjust the electric power required to drive a plurality of loads connected in parallel. The multi-load feedback circuit according to the present invention comprises a plurality of semiconductor switches, with each semiconductor switch including a first terminal, a second terminal and a third terminal, wherein the first terminals are coupled to a common reference voltage for controlling the plurality of semiconductor switches to be in a conducting state or in a cutoff state, the second terminals are coupled to corresponding loads out of a plurality of loads, and the third terminals are mutually coupled to generate a detection signal, thereby allowing the load driving circuit to accordingly adjust the electric power required to drive the plurality of loads.

The present invention also provides a load driving circuit for driving plural series connections of LEDs connected in parallel. The load driving circuit according to the present invention comprises an electrical power supply, a current balancing circuit and a multi-load feedback circuit. The electrical power supply is coupled to plural series connections of LEDs for driving light emissions in such plural series connections of LEDs. The current balancing circuit includes a plurality of current balancing terminals correspondingly coupled to the plural series connections of LEDs for balancing the current flowing through such plural series connections of LEDs. The multi-load feedback circuit includes a plurality of semiconductor switches, with each semiconductor switch being respectively coupled to a corresponding current balancing terminal among the plurality of current balancing terminals. Herein the multi-load feedback circuit generates a detection signal based on the voltage levels associated with the current balancing terminals corresponding to those semiconductor switches conducted, thereby allowing the electrical power supply to adjust the power required to drive the plural series connections of LEDs according to the detection signal.

Therefore, the driving electrical power provided by the load driving circuit according to the present invention can be set to a lower level and adjusted depending on the electrical power actually required by the LED module, so as to improve the efficiency thereof.

The aforementioned summary as well as the detailed descriptions set forth hereinafter both aim to further illustrate the scope of the present invention. Other purposes and advantages in relation to the present invention will be construed with reference to the following specifications and appended drawings thereof.

### BRIEF DESCRIPTION OF THE DRAWINGS

FIG. 1 is a schematic diagram of a conventional constant current driving apparatus for LEDs.

FIG. 2 is a schematic diagram of the load driving circuit according to the present invention.

FIG. 3 is a schematic diagram of the multi-load feedback circuit according to a first embodiment of the present invention.

FIG. 4 is a schematic diagram of the multi-load feedback circuit according to a second embodiment of the present invention.

FIG. 5 is a schematic diagram of the multi-load feedback circuit according to a third embodiment of the present invention.

FIG. 6 is a schematic diagram of the multi-load feedback circuit according to a fourth embodiment of the present invention.

FIG. 7 is a schematic diagram of the multi-load feedback circuit according to a fifth embodiment of the present invention.

### DETAILED DESCRIPTION OF THE PREFERRED EMBODIMENTS

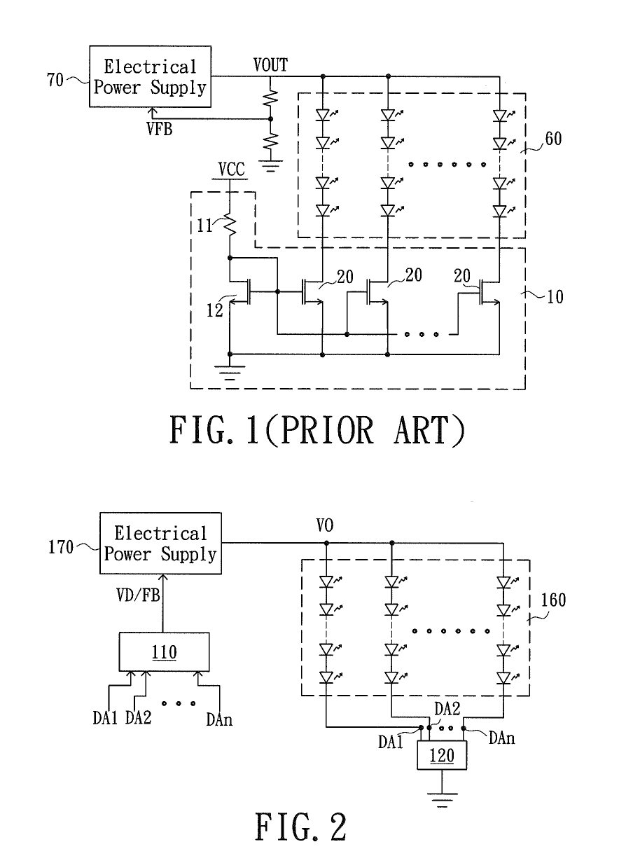

Referring now to FIG. 2, wherein a schematic diagram of the load driving circuit according to the present invention is shown. The depicted load driving circuit comprises a multi-load feedback circuit 110, a current balancing circuit 120 and an electrical power supply 170 for driving a Light Emitting Diode (LED) module 160, in which the LED module 160 consists of plural series connections of LEDs connected in parallel, with each series connection of LEDs being composed of a plurality of LEDs connected in series. The electrical power supply 170 is coupled to the plural series connections of LEDs in the LED module 160, thereby providing an output voltage VOUT to drive the plural series connections of LEDs for illuminations. The current balancing circuit 120 consists of a plurality of current balancing terminals DA1˜DAn correspondingly coupled to said plural series connections of LEDs for balancing the current flowing through such plural series connections of LEDs, such that the current flowing therein through becomes approximately consistent. The multi-load feedback circuit 110 is coupled to the current balancing terminals DA1˜DAn for generating a detection signal FB based on the voltage level associated with each of the current balancing terminals, thereby allowing the electrical power supply 170 to adjust the electrical power required to drive the LED module 160 based on the detection signal VD or the feedback signal FB. In this way, the voltage levels associated with the plurality of current balancing terminals DA1˜DAn can be ensured to be above a predetermined level, yet confined not to become excessively high, thus enabling maintenance of high performance in the load driving circuit.

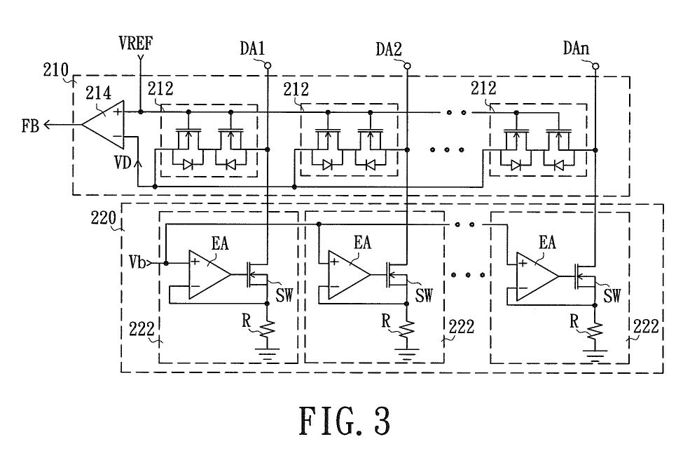

Next, refer to FIG. 3, wherein a schematic diagram of the multi-load feedback circuit according to a first embodiment of the present invention is shown. The present multi-load feedback circuit 210 comprises a plurality of semiconductor switches 212 and a determining circuit 214. Each semiconductor switch has a first terminal, a second terminal and a third terminal, in which the first terminals being coupled to a common reference voltage VREF. The second terminals are individually coupled to the plurality of current balancing terminals DA1˜DAn of the current balancing circuit 220; that is, coupled to the plural series connections of LEDs in the LED module 160. The third terminals are mutually coupled and also coupled to the determining circuit 214, thereby generating a detection signal VD to the determining circuit 214.

The current balancing circuit 220 includes a plurality of current balancing units 222, with each current balancing unit 222 including a transistor switch SW, a resistor R and an error amplifier EA. The resistor R generates a current detection signal to the inverse terminal of the error amplifier EA based on the current flowing through a corresponding current balancing terminal among the current balancing terminals DA1˜DAn. The non-inverse terminal of the error amplifier EA receives a current reference signal Vb, and accordingly controls the effectively equivalent resistance of the transistor switch SW, such that the voltage level of the current detection signal is equivalent to the level of the current reference signal Vb. Therefore, the current balancing unit 222 is able to control the current flowing through the series connection of LEDs coupled to the current balancing terminals DA1˜DAn.

In the present embodiment, each semiconductor switch 212 in the multi-load feedback circuit 210 consists of two Metal-Oxide-Semiconductor Field Effect Transistors (MOSFET's), in which the drains of the two MOSFET's are electrically connected and the gates thereof are conjunctively connected to the common reference voltage VREF. One of the drains of the two MOSFET's is coupled to a corresponding current balancing terminal among the plurality of current balancing terminals DA1˜DAn, while the other one drain is coupled to the determining circuit 214; Additionally, the body diodes of the two MOSFET's are arranged in a mutually reverse direction, so as to prevent transfers of the current signal or voltage signal via the body diodes of the two MOSFET's when the two MOSFET's are both in a cutoff state. The determining circuit 214 includes a comparator, in which the inverse terminal of the comparator receives the detection signal VD and the non-inverse terminal of the comparator receives the common reference voltage VREF; the comparator generates the feedback signal FB from the output terminal.

When the voltage level associated with any one of the plurality of current balancing terminals DA1˜DAn is lower than the common reference voltage VREF by more than a predetermined voltage difference (i.e., the conducting voltage difference of the semiconductor switch 212), the semiconductor switch 212 is in a conducting state, otherwise in a cutoff state. That is, the semiconductor switch 212 determines the state of conductivity or cutoff based on the voltage level of the corresponding current balancing terminal, and also determines the level of the detection signal VD based on the voltage level of the current balancing terminal corresponding to the conductive semiconductor switch 212. In the present embodiment, since the semiconductor switch 212 includes two MOSFET's, the level of the detection signal VD is an average value of the voltage levels of the current balancing terminals corresponding to the conductive semiconductor switch 212, and lower than the common reference voltage VREF by at least a predetermined voltage difference. Therefore, the determining circuit 214 outputs a feedback signal FB of high level. The electrical power supply 170 shown in FIG. 2 increases the electrical power required to drive the LED module 160 upon reception of the feedback signal FB of high level; that is, the output voltage V0 is elevated so as to increase the voltage level at the current balancing terminals DA1˜DAn, until the feedback signal FB turns to low level, thus allowing the levels at the current balancing terminals DA1˜DAn all to be higher than or equal to the common reference voltage VREF.

Consequently, the load driving circuit according to the present invention adjusts the electrical power required to drive the LED module 160 based on the signal from the multi-load circuit, such that the voltage level at each current balancing terminal is higher than or equal to a predetermined voltage; yet when the voltage level at the current balancing terminal having the lowest level is higher than or equal to a predetermined level, the load driving circuit no longer increases the electrical power required to drive the LED module 160 in order to confine the voltage difference between the current balancing terminal and ground into a limited range, thus enabling maintenance of preferably higher efficiency in the circuitry.

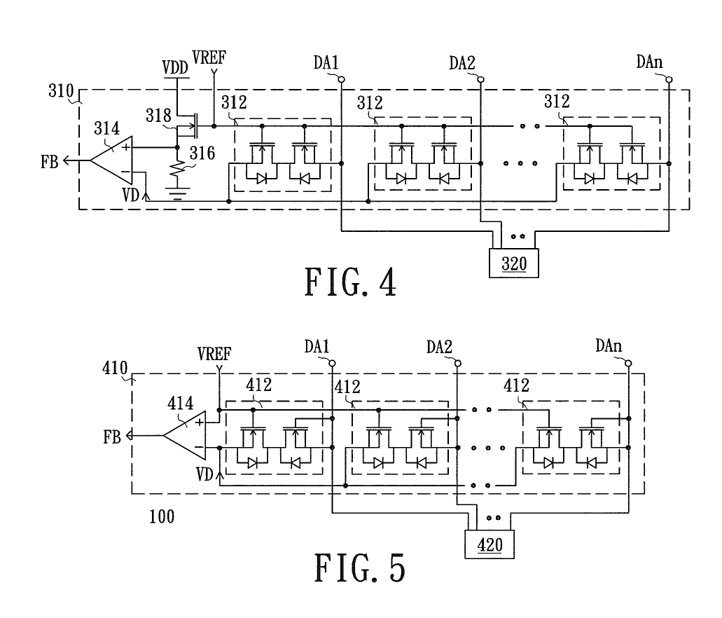

Refer next to FIG. 4, wherein a schematic diagram of the multi-load feedback circuit according to a second embodiment of the present invention is shown. The multi-load feedback circuit 310 comprises a plurality of semiconductor switches 312, an error amplifier 314, a resistor 316 and a transistor switch 318. Each semiconductor switch 312 consists of a first terminal, a second terminal and a third terminal, with the first terminals being coupled to a common reference voltage VREF. The second terminals are individually coupled to the plurality of current balancing terminals DA1˜DAn of the current balancing circuit 320. The third terminals are mutually coupled and also coupled to the error amplifier 314 thereby generating a detection signal VD to the error amplifier 314. In the present embodiment, the circuits and operations of the semiconductor switch 312 is identical to which of the semiconductor switch 212 illustrated in FIG. 3, descriptions thereof are thus omitted for brevity.

The most significant difference between the multi-load feedback circuit 310 of the present embodiment and the multi-load feedback circuit 210 shown in FIG. 3 lies in that the determining circuit 214 is replaced by the error amplifier 314, the resistor 316 and the transistor switch 318. The drain of the transistor switch 318 is coupled to a drive voltage VDD, the source of the transistor switch 318 is coupled to the resistor 316 and the non-inverse terminal of the error amplifier 314, and the gate thereof is coupled to the common reference voltage VREF. Therefore, the transistor switch 318 is maintained in a conducting state and a conducting voltage difference exists between the gate and the source; in other words, the signal level received at the non-inverse terminal of the error amplifier 314 is the common reference voltage VREF minus the conducting voltage difference. The voltage drop in the conducting voltage may also occur when the semiconductor switch 312 becomes conductive because the level at the corresponding current balancing terminal among the current balancing terminals DA1˜DAn is lower than the common reference voltage VOUT by a predetermined voltage difference. Consequently, through the placements of the resistor 316 and the transistor switch 318, it is possible to compensate the voltage drop occurring in the semiconductor switch 312. Additionally, the error amplifier 314 outputs the feedback signal FB based on the voltage difference between the inverse terminal and the non-inverse terminal so as to allow the electrical power supply 170 to adjust the power required to drive the LED module 160, thereby making the voltage levels at the current balancing terminals DA1˜DA1 become higher than or equal to (common reference voltage VOUT—conducting voltage difference).

Subsequently, refer to FIG. 5, wherein a schematic diagram of the multi-load feedback circuit according to a third embodiment of the present invention is shown. Compared with the multi-load feedback circuit 212 depicted in FIG. 3, the source in the multi-load feedback circuit 412 is coupled to the MOSFET of the current balancing terminals DA1˜DAn, its gate is alternatively coupled to a corresponding current balancing terminal, rather than the common reference voltage VREF, so the MOSFET is maintained in a cutoff state. When the level at the corresponding current balancing terminal is lower than the common reference voltage VREF by a predetermined voltage difference thereby causing the multi-load feedback circuit 412 to be in a conducting state, the signal of the current balancing terminal will be passed to the inverse terminal of the comparator 414 through the body diode of the MOSFET in cutoff and another MOSFET in conduction. As a result, the multi-load feedback circuit 412 according to the present embodiment can, as the multi-load feedback circuits illustrated in the previous embodiments, control the load driving circuit to adjust the electrical power required to drive the LED module 160 through the feedback signal FB generated by the comparator 414. Since one of the two MOSFET's in the multi-load feedback circuit 412 is in a cutoff state all the time that only the feature of diode is demonstrated by the body diode, the current balancing terminal having the lowest voltage level among the current balancing terminals DA1˜DAn dominates the level of the detection signal VD, such that the level of the current balancing terminal having the lowest voltage is higher than or equal to a predetermined voltage level, thus ensuring the levels of all current balancing terminals DA1˜DAn to be higher than or equal to the predetermined voltage level.

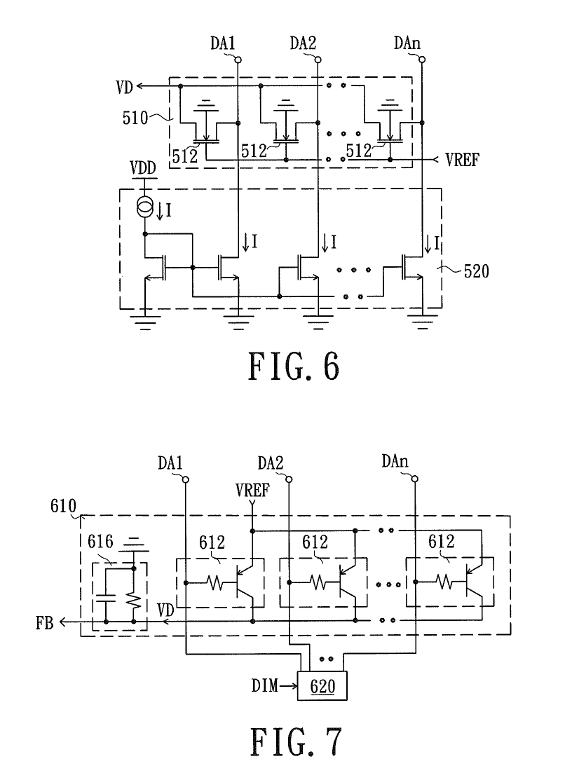

Next, refer to FIG. 6, wherein a schematic diagram of the multi-load feedback circuit according to a fourth embodiment of the present invention is shown. The multi-load feedback circuit 510 comprises a plurality of semiconductor switches 512, with each semiconductor switch 512 consisting of an N-type transistor switch whose gate is coupled to the common reference voltage VOUT, one of the source and the drain thereof being coupled to a corresponding current balancing terminal among the current balancing terminals DA1˜DAn of the current balancing circuit 520, and the other one being mutually coupled in order to generate a detection signal VD, while the base thereof coupled to ground. Due to grounding at the base, the reverse biased body diode of the N-type transistor switch can be ensured to be cut off. Hence, the plurality of semiconductor switches 512 transfer the levels of the current balancing terminals DA1˜DAn to the detection signal VD only when the voltage levels at the current balancing terminals DA1˜DAn become lower than the common reference voltage VREF by a predetermined voltage difference. The level of detection signal VD at this point can be an average value of the levels at the corresponding current balancing terminals of the conductive semiconductor switch 512, as the embodiment shown in FIG. 3. At this moment, the electrical power supply 170 increases the electrical power required to drive the LED module 160 in accordance with the detection signal VD thereby individually elevating the level at the current balancing terminal among the current balancing terminals DA1˜DAn which is lower than the common reference voltage VREF by a predetermined voltage difference, until all of the semiconductor switches 512 are in a cutoff state.

Furthermore, the multi-load feedback circuit according to the present invention may operate conjunctively with the current balancing circuit formed by the plurality of current balancing units 222 shown in FIG. 3, and may also alternatively cooperate with the current balancing circuit 520 formed by a current mirror circuit or other circuits enabling the current balancing effect. In FIG. 6, the current mirror circuit consists of multiple transistor switches with gates and sources thereof being mutually connected, wherein the current I generated by a current source is mirrored and thus flows through each transistor switch, such that an equivalent current is conducted through the current balancing terminals DA1˜DAn formed by the drains of the transistor switches.

Refer now to FIG. 7, wherein a schematic diagram of the multi-load feedback circuit according to a fifth embodiment of the present invention is shown. Compared with the embodiment depicted in FIG. 6, the multi-load feedback circuit 610 comprises a plurality of semiconductor switches 612, with each semiconductor switch 612 being formed by a bipolar junction transistor and a resistor. The emitters of the bipolar junction transistors are coupled to the common reference voltage VREF, the bases of the bipolar junction transistors are coupled to the current balancing terminals DA1˜DAn in the current balancing circuit 620 through the resistor, and the collectors of the bipolar junction transistors are mutually connected. When the level at the current balancing terminal having the lowest level among the current balancing terminals DA1˜DAn is lower than the common reference voltage VREF by a predetermined voltage difference, the corresponding bipolar junction transistor becomes conductive and the level at current balancing terminal having the lowest voltage level dominates the level in the detection signal VD.

In the present embodiment, the current balancing circuit may receive a dimming signal DIM as the basis for current provision or blockage. At this point, due to such a signal, variations in the levels at the current balancing terminals DA1˜DAn may occur, so the detection signal VD can be filtered through a filter circuit 616 in order to filter the noises produced in dimming out of the detection signal VD, and a feedback signal FB can be generated thereby allowing the load driving circuit to adjust the provided electrical power in accordance with the feedback signal FB.

In summary of the aforementioned specifications, the present invention indeed satisfies the three requirements on patent applications: novelty, unobviousness and utility. The present invention has been disclosed as above through preferred embodiments thereof, and those skilled ones in the art can appreciate that such embodiments are merely for the purpose of illustrating the present invention rather than restricting the scope of the present invention thereto. It should be noticed that all effectively equivalent modifications, alternations or substitutions are deemed as being included in the scope of the present invention. Therefore, the scope of the present invention intended to be legally protected should be delineated by the claims set forth hereunder.

What is claimed is:

1. A multi-load feedback circuit allowing a load driving circuit to adjust the electrical power used to drive a plurality of loads connected in parallel, comprising:
a plurality of semiconductor switches, with each semiconductor switch consisting of a first terminal, a second terminal and a third terminal, wherein the first terminals are coupled to a common reference voltage for controlling the plurality of semiconductor switches to be in a cutoff state or in a conducting state, the second terminals are coupled to corresponding loads out of the plurality of loads, the third terminals are mutually coupled to generate a detection signal, thereby allowing the load driving circuit to accordingly adjust the electric power required to drive the plurality of loads.

2. The multi-load feedback circuit according to claim 1, wherein the plurality of loads are plural series connections of Light Emitting Diodes (LEDs), with each series connection of LEDs consisting a plurality of LEDs connected in series.

3. The multi-load feedback circuit according to claim 1, further comprising a filter circuit for filtering the detection signal and generating a feedback signal, thereby allowing the load driving circuit to adjust the electrical power required to drive the plurality of loads based on the feedback signal.

4. The multi-load feedback circuit according to claim 3, wherein the filter circuit includes an error amplifier.

5. The multi-load feedback circuit according to claim 1, further comprising a determining circuit used to generate a feedback signal based on the detection signal, thereby allowing the load driving circuit to adjust the electrical power required to drive the plurality of loads based on the feedback signal.

6. The multi-load feedback circuit according to claim 5, wherein each semiconductor switch includes a first Metal-Oxide-Semiconductor Field Effect Transistor (MOSFET) and a second MOSFET, in which the drains of the first MOSFET and the second MOSFET are electrically connected, the gates of the first MOSFET and the second MOSFET are coupled to the common reference voltage, the source of the first MOSFET is coupled to a corresponding load among the plurality of loads, and the body diodes in the first MOSFET and the second MOSFET are arranged in a mutually reverse direction.

7. The multi-load feedback circuit according to claim 5, wherein each semiconductor switch includes a first Metal-Oxide-Semiconductor Field Effect Transistor (MOSFET) and a second MOSFET, in which the drains of the first MOSFET and the second MOSFET are electrically connected, the gate and the source of the first MOSFET are mutually connected, the gate of the second MOSFET is coupled to the common reference voltage, the source of the first MOSFET is coupled to a corresponding load among the plurality of loads, and the body diodes in the first MOSFET and the second MOSFET are arranged in a mutually reverse direction.

8. The multi-load feedback circuit according to claim 5, wherein each semiconductor switch includes an MOSFET, in which the gate of the MOSFET is coupled to the common reference voltage, the source of the MOSFET is coupled to a corresponding load among the plurality of loads, and the base of the MOSFET is connected to ground.

9. The multi-load feedback circuit according to claim 5, wherein each semiconductor switch includes a bipolar junction transistor, in which the emitter of the bipolar junction transistor is coupled to the common reference voltage and the base of the bipolar junction transistor is coupled to a corresponding load among the plurality of loads.

10. The multi-load feedback circuit according to claim 5, wherein the determining circuit includes a comparator, in which the inverse terminal of the comparator receives the detection signal and the non-inverse terminal thereof receives the common reference voltage.

11. The multi-load feedback circuit according to claim 5, wherein the determining circuit includes a comparator and a transistor switch, in which the transistor switch has a first terminal, a second terminal and a control terminal, and the first terminal is coupled to a drive voltage, the control terminal is coupled to the common reference voltage, the second terminal is coupled to the non-inverse terminal of the comparator, and the inverse terminal of the comparator is applied to receive the detection signal.

12. A load driving circuit for driving plural series connections of LEDs connected in parallel, comprising:
an electrical power supply, being coupled to the plural series connections of LEDs for driving light emissions in such plural series connections of LEDs;
a current balancing circuit, including a plurality of current balancing terminals correspondingly coupled to the plural series connections of LEDs for balancing the current flowing through such plural series connections of LEDs; and
a multi-load feedback circuit, including a plurality of semiconductor switches, being respectively coupled to a corresponding current balancing terminal among the plurality of current balancing terminals, and determining the conducting state or cutoff state for the corresponding semiconductor switch based on the voltage level associated with each of the current balancing terminals;
whereby the multi-load feedback circuit generates a detection signal based on the voltage level associated with the current balancing terminals corresponding to those semiconductor switches conducted, thereby allowing the electrical power supply to adjust the power required to drive the plural series connections of LEDs according to the detection signal.

13. The load driving circuit according to claim 12, wherein the current balancing circuit is a current mirror circuit.

14. The load driving circuit according to claim 12, wherein the current balancing circuit is composed of a plurality of current sources coupled to the plural series connections of LEDs, thereby allowing a largely equivalent current to flow through the plural series connections of LEDs.

15. The load driving circuit according to claim 12, wherein the multi-load feedback circuit includes a filter circuit for filtering the detection signal and generating a feedback signal, thereby allowing the load driving circuit to adjust the electrical power required to drive the plural series connections of LEDs based on the feedback signal.

16. The load driving circuit according to claim 12, wherein the electrical power supply adjusts the voltage required to drive the plural series connections of LEDs based on the detection signal, thereby maintaining the voltage level associated with each current balancing terminal to be above a predetermined voltage level.

17. The load driving circuit according to claim 12, wherein each semiconductor switch includes a first Metal-Oxide-Semiconductor Field Effect Transistor (MOSFET) and a second MOSFET, in which the drains of the first MOSFET and the second MOSFET are electrically connected, the gates of the first MOSFET and the second MOSFET are coupled to the common reference voltage, the source of the first MOSFET is coupled to a corresponding current balancing terminal among the plurality of current balancing terminals, and the body diodes in the first MOSFET and the second MOSFET are arranged in a mutually reverse direction.

18. The load driving circuit according to claim 13, wherein each semiconductor switch includes a first Metal-Oxide-Semiconductor Field Effect Transistor (MOSFET) and a second MOSFET, in which the drains of the first MOSFET and the second MOSFET are electrically connected, the gate and the source of the first MOSFET are mutually connected, the gate of the second MOSFET is coupled to the common reference voltage, the source of the first MOSFET is coupled to a corresponding current balancing terminal among the plurality of current balancing terminals, and the body diodes in the first MOSFET and the second MOSFET are arranged in a mutually reverse direction.

19. The load driving circuit according to claim 12, wherein each semiconductor switch includes an MOSFET, in which the gate of the MOSFET is coupled to the common reference voltage, the source of the MOSFET is coupled to a corresponding current balancing terminal among the plurality of current balancing terminals and the base of the MOSFET is connected to ground.

20. The load driving circuit according to claim 12, wherein each semiconductor switch includes a bipolar junction transistor, in which the emitter of the bipolar junction transistor is coupled to the common reference voltage, and the base of the bipolar junction transistor is coupled to a corresponding current balancing terminal among the plurality of current balancing terminals.
